(19) United States
(12) Patent Application Publication
(10) Pub. No.: US 2004/0021236 A1
(43) Pub. Date: Feb. 5, 2004

(54) Process for producing plastic optical member and plastic optical member obtained by said process

(75) Inventors: Masataka Sato, Shizuoka (JP); Takahito Miyoshi, Shizuoka (JP); Yukio Shirokura, Shizuoka (JP); Tohru Ogura, Shizuoka (JP); Yasuhiro Koike, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD., KOIKE, Yasuhiro

(21) Appl. No.: 10/364,376

(22) Filed: Feb. 12, 2003

(30) Foreign Application Priority Data
Feb. 13, 2002 (JP) 2002-034832

(51) Int. Cl. G02B 6/18

(52) U.S. Cl. 264/1.24; 385/102

(57) ABSTRACT

A process for producing a plastic optical member is provided that includes injecting a polymerizable monomer composition into a hollow plastic tube and polymerizing the composition within the hollow tube, wherein prior to injecting the composition one end of the hollow tube is sealed with a resin. The resin may have a composition different from that of the plastic forming the hollow tube. A process for producing a plastic optical fiber base material is also provided that includes injecting a polymerizable monomer composition into a hollow plastic tube and polymerizing the composition within the hollow tube, wherein prior to injecting the composition one end of the hollow tube is sealed with a resin. Furthermore, a process for producing a plastic optical fiber is provided that includes drawing the plastic optical fiber base material obtained by the above process. Moreover, also provided are a plastic optical member and a plastic optical fiber, which are produced by the above processes.

### BACKGROUND OF THE INVENTION

1. Field of the Invention

The present invention relates to a process for producing a plastic optical member and, in particular, a process for producing a plastic optical member such as a distributed refractive index type plastic optical transmitter.

2. Description of the Related Art

A plastic optical member has the advantages that its production and processing are easy and its cost is low compared with a quartz type optical member having the same structure, and in recent years the application thereof in various products such as optical fiber and optical lenses has been attempted. Since strands of the optical plastic fiber are formed entirely from a plastic, there is the drawback that its transmission loss is large compared with the quartz type, but it has the advantages that it has good flexibility, is lightweight, and has good processibility, it is easily produced as a fiber having a larger aperture than that of the quartz type optical fiber, and it can be produced at low cost. Various studies of it as an optical communication transmission medium for short distances where the extent of the transmission loss is not a serious problem are therefore being carried out.

The plastic optical fiber generally comprises a core and a shell (called a ‘cladding’ in the present invention), the core being formed from an organic compound constituting a polymer matrix and the shell being formed from an organic compound having a different refractive index (generally a lower refractive index) from the core. In particular, a distributed refractive index type plastic optical fiber comprising a core having a refractive index distribution from the center to the outside can transmit an optical signal having an increased bandwidth, and its application as an optical fiber having a high transmission capacity has been noted in recent years. As one process for producing such a distributed refractive index type plastic optical fiber, there is a method in which an optical fiber base material (also called a ‘preform’ in the present invention) is prepared using an interfacial gel polymerization method, and the preform is then drawn. In one example of this process, a monomer such as methyl methacrylate (MMA) is firstly placed in a sufficiently rigid container, and the monomer is polymerized while rotating the container, thus forming a cylindrical tube made of a polymer such as poly(methyl methacrylate) (PMMA). This cylindrical tube region forms a cladding of an optical fiber formed by drawing the preform.

Next, a core having a refractive index distribution is formed in the hollow part of the cylindrical tube. With regard to a method for imparting a refractive index distribution to the core, for example, JP-A-2-16504 (JP-A denotes a Japanese unexamined patent application publication) discloses a method in which a polymerizable mixture of two or more types of materials in layered form, the materials having different refractive index distributions, is formed by coaxial extrusion. Furthermore, with regard to the methods for obtaining a preform by polymerization, there are the following disclosures. JP-A-5-181023 and JP-A-6-194530 disclose a method in which a mixture containing a monomer that can form a core having a different refractive index from that of a polymer forming a cladding, a polymerization initiator, etc. is thermally polymerized while adding it dropwise to the interior of the cladding made of the polymer. WO 93/08488 discloses a method in which, after a cylindrical tube made of a polymer is filled with a mixture comprising a monomer, a polymerizable refractive index increasing agent, and a polymerization initiator, the mixture is thermally polymerized to form a core, and a refractive index distribution is formed due to a concentration distribution of the refractive index adjusting agent, etc. contained in the core. JP-A-4-9730 discloses a method in which the composition ratio of polymers having different refractive indexes is changed successively. The preforms thus obtained are thermally drawn in an atmosphere of about 180° C. to about 250° C. to give a distributed refractive index type plastic optical fiber.

In the case where the hollow cladding tube is formed by polymerization while rotating the polymerization container (hereinafter, called ‘rotational polymerization’), since opposite ends of the polymerized cladding tube are open, it is necessary to close at least one of the ends when carrying out polymerization of the core. However, when one end is closed by bonding to the end a material that does not dissolve in the monomer that is used for the core polymerization, microvoids remain in the base section, and noticeable bubbles are observed in the core when the core polymerization is completed. Furthermore, in a case where polymerization under increased pressure is employed, there is a possibility that the polymerizable monomer might leak through a sealed area, thus greatly degrading the productivity. This also happens when one end is sealed with a plug-shaped material, and it is particularly preferable to form a cladding tube with one end completely sealed in advance.

One of the problems to be solved is that, in the case where polymerization of a core is completed with high productivity by injecting a polymerizable monomer into the hollow part of such a hollow tube, it is necessary to employ polymerization under severe conditions such as increased or reduced pressure, and if one end of the hollow tube is not sealed stably, then polymerization of the core cannot be carried out with high productivity. However, when one end of the hollow tube is closed by thermal melting or by hermetically bonding a resin using an adhesive, the problems of trace amounts of bubbles mixed during the operation migrating into the core and forming larger bubbles and, furthermore, the polymerizable monomer leaking out become noticeable, and there has therefore been a desire for an appropriate method for sealing the end part.

### BRIEF SUMMARY OF THE INVENTION

The present invention has been achieved in view of the above-mentioned various problems, and it is an object of the present invention to provide a process for producing a plastic optical member with excellent productivity, the process enabling preparation of a hollow tube with one end stably sealed, and a plastic optical member obtained by the process.

The above-mentioned object has been attained by a process for producing a plastic optical member, the process comprising injecting a polymerizable monomer composition into a hollow plastic tube and polymerizing the composition within the hollow tube, wherein prior to injecting the composition one end of the hollow tube is sealed with a resin.

### BRIEF DESCRIPTION OF THE DRAWING

FIG. 1 shows an example of polymerization temperature pattern employed for core polymerization exemplified in Example 1.

### DETAILED DESCRIPTION OF THE INVENTION

The above-mentioned means for attaining the object is repeated below, and is followed by a list of preferable embodiments.

(1) A process for producing a plastic optical member, the process comprising injecting a polymerizable monomer composition into a hollow tube made of a plastic and polymerizing the composition within the hollow tube, wherein prior to injecting the composition one end of the hollow tube is sealed with a resin,

(2) a process for producing a plastic optical member, the process comprising injecting a polymerizable monomer composition into a hollow tube made of a plastic and polymerizing the composition within the hollow tube, wherein prior to injecting the composition one end of the hollow tube is sealed with a resin that has a composition different from that of the plastic forming the hollow tube,

(3) the process for producing a plastic optical member according to (1) or (2) wherein the step of sealing one end of the hollow tube is carried out after forming the hollow tube,

(4) the process for producing a plastic optical member according to (1) or (2) wherein the step of sealing one end of the hollow tube is carried out at substantially the same time as the hollow tube is formed,

(5) the process for producing a plastic optical member according to (1) or (2) wherein the hollow tube is formed after forming an end part that seals the hollow tube,

(6) the process for producing a plastic optical member according to any one of (1) to (5) wherein the resin used for sealing comprises a material having an interaction with the plastic of the hollow tube,

(7) the process for producing a plastic optical member according to any one of (1) to (6) wherein the resin used for sealing comprises a material that does not dissolve in the polymerizable composition.

(8) the process for producing a plastic optical member according to any one of (1) to (7) wherein the melting point of the resin that seals one end of the hollow tube is equal to or greater than a temperature employed for cladding polymerization and a temperature employed for core polymerization,

(9) a plastic optical member obtained by the production process according to any one of (1) to (8),

(10) the plastic optical member according to (9) wherein the optical member has a region that has a refractive index distribution, and

(11) the plastic optical member according to (10) wherein the refractive index distribution varies, in a cross section, from the center to the outside.

The hollow tube used in the present invention is formed from a plastic and corresponds to the portion forming a cladding in the production of a plastic optical member. This hollow plastic tube preferably has good transparency to transmitted light.

In the production process of the present invention, the hollow plastic tube for the plastic optical member preform that is used preferably has a lower refractive index than that of the core in order to retain in the core an optical signal that is transmitted and, furthermore, preferably has good transparency to the light that is transmitted. Examples thereof include homopolymers such as poly(methyl methacrylate) (PMMA), poly(benzyl methacrylate) (PBzMA), polystyrene (PSt), deuterated poly(methyl methacrylate) (PMMA-d8, d5, or d3), poly(trifluoroethyl methacrylate) (P3FMA), and poly(hexafluoroisopropyl 2-fluoroacrylate) (PHFIP 2-FA), copolymers formed from at least two of the above types of monomers, and mixtures thereof.

In order to avoid impairing the transparency after polymerization, it is preferable to minimize contamination by impurities and foreign matter that might cause scattering. It is preferable to use the same starting material for the cladding as that used for the polymer forming the core from the point of view of maintaining the transparency.

The material used for sealing one end of the hollow plastic tube may have the same resin composition as that of the hollow tube, but it is preferable for the material to have a different composition from that of the hollow tube so that it can be removed easily at an appropriate stage in the production of the plastic optical member.

The material for sealing one end of the hollow tube preferably has a melting or softening point that is higher than the polymerization temperature for the cladding and the polymerization temperature for the core. This sealing material is preferably a resin having a melting point of at least 100° C., and more preferably at least 120° C.

With regard to such resins, there can be cited resins having fluorine (fluorine-containing resins), polyolefin resins, etc., and specific examples thereof include poly(vinylidene fluoride) (PVDF), poly(vinyl fluoride) (PVF), poly(tetrafluoroethylene) (PTFE), tetrafluoroethylene/perfluoroalkyl vinyl ether copolymer (PFA), tetrafluoroethylene/hexafluoropropylene copolymer (FEP), tetrafluoroethylene/ethylene copolymer (ETFE), polyamide resins, and maleimide resins.

Examples of the sealing resin that can be used preferably for the hollow tube, in particular one made of PMMA, include PVDF and PVF.

The timing with which one end of the hollow tube is sealed with the resin may be prior to formation of the hollow tube with at least the other end open, or at substantially the same time as formation of the hollow tube, or subsequent to formation of the hollow tube.

One end of the hollow tube can be sealed at the same time as formation thereof. In this case, the hollow plastic tube may be a hollow tube formed from a plastic that has been polymerized or condensation-polymerized in advance. This hollow tube can be produced by, for example, injection molding. In this case, the interior of the injection-molded hollow tube is filled with a sealing resin in advance, and cutting and separating in this filled section can simultaneously produce two hollow tube portions having one end sealed with the resin.

It is also possible to injection-mold a hollow tube and a sealed end at substantially the same time. In this case, a sealing resin is injected into an end-forming part of an injection molding die and, at substantially the same time, a plastic preferably having a different composition is injected into a tube-forming part thereof, thereby producing the sealed part and the tube portion at substantially the same time. As with the above-mentioned method, this method is also suitable for bulk production.

It is also possible, after forming a hollow tube, to seal one end of the hollow tube. As an example, in the case where small scale production is carried out for convenience, it is possible to employ a method in which, after producing a hollow tube in advance by injection molding or thermal polymerization, one end thereof is sealed. For example, inserting a hollow PMMA tube into an appropriate amount of molten PVDF can seal one end of the tube.

One end of a hollow tube can also be formed prior to formation of the hollow tube. One embodiment thereof is described below. When producing a hollow tube by polymerization, a polymerizable monomer for formation of the hollow tube may be polymerized while rotating a container containing the monomer to give a cladding. In this case, before forming the cladding using the polymerization container, a material that can completely bond to the polymerized cladding may be fitted into one end of the polymerization container, thereby providing the cylindrical cladding tube with one end completely sealed.

As a preferred embodiment of the present invention, a hollow tube has an outer diameter of 1 to 50 mm and has a thickness of 0.3 to 20 mm.

In accordance with one embodiment of the process for producing a plastic optical member of the present invention, a monomer for formation of a core or a composition containing a monomer and a polymer of the monomer is injected into the interior of a hollow tube with one end sealed with a resin, and the core is polymerized with heat or light.

The present invention is explained further in detail below.

With regard to the optical member of the present invention, a preform is firstly prepared, and by processing the preform according to the application various members can be obtained. For example, an optical fiber can be obtained by drawing the preform, a light guide can be obtained by slicing the preform in a cross-sectional direction and, furthermore, a lens can be obtained in the case where the preform has a region having a refractive index distribution.

First, various starting materials for the plastic optical member preforms used in the production process of the present invention are explained.

The starting monomers used for forming the cladding have already been explained.

In the present invention, the core of the plastic optical member preform is formed from a polymer. The core is not particularly limited as long as it is optically transparent to the light to be transmitted, but it is preferable to use a material having a low transmission loss for the optical signal to be transmitted. Examples thereof include (meth)acrylic acid resins which are (meth)acrylate ester polymer including straight-chain alkyl (meth)acrylate resins such as poly(methyl methacrylate) (PMMA) and copolymers thereof and alicyclic hydrocarbon (meth)acrylate such as isobornyl methacrylate(IBXMA). In the case where the optical member is used in an application involving near-infrared light, since absorption loss occurs due to the vibration mode of C-H bonds contained in the optical member, the C-H bonds are deuterated as described in WO 93/08488, or a polymer is formed using a monomer substituted with fluorine, examples thereof including homopolymers such as deuterated poly(methyl methacrylate) (PMMA-d8), poly(trifluoroethyl methacrylate) (P3FMA), and poly(hexafluoroisopropyl 2-fluoroacrylate) (PHFIP 2-FA), copolymers of two or more types of the above monomers, and mixtures thereof. It is preferable to form a core from a single polymer by choosing a material that can easily be bulk-polymerized. As in the case with the cladding, it is preferable to minimize contamination by impurities and foreign matter that might cause scattering in order to avoid impairing the transparency after polymerization.

It is preferable for the core to have a refractive index distribution from the center to the outside (hereinafter, termed ‘distributed refractive index type core’) since this can give a distributed refractive index type plastic optical fiber having high transmission capacity, and a high performance plastic lens. The distributed refractive index type core can be formed using, for example, a refractive index adjusting agent. The refractive index adjusting agent can be included in the core by adding it to a starting monomer for the core and then polymerizing the monomer. The refractive index adjusting agent refers to an agent, as described in WO 93/08488 and JP-A-5-173026, that has properties such that, when comparing polymers formed from a monomer, the difference in solubility parameter is at most 7 (cal/cm³)^{1/2} and the difference in refractive index is at least 0.001, and a polymer containing this agent has a higher refractive index than that of a polymer to which it is not added. Any agent can be used as long as it has the above-mentioned properties, can coexist stably with a polymer, and is stable under polymerization conditions (polymerization conditions such as heating and the application of pressure) for the above-mentioned starting monomer. Examples thereof include benzyl benzoate (BEN), diphenyl sulfide (DPS), triphenyl phosphate (TPP), benzyl n-butyl phthalate (BBP), diphenyl phthalate (DPP), biphenyl (BP), diphenylmethane (DPM), tricresyl phosphate (TCP), and diphenyl sulfoxide (DPSO), and among these BEN, DPS, TPP, and DPSO are preferable.

Adjusting the concentration and distribution of the refractive index adjusting agent in the core can change the refractive index of the plastic optical member preform to a desired value. The amount thereof added is chosen appropriately according to the application and the starting material for the core used in combination therewith.

In addition, other additives can be added to the core and the cladding in ranges that do not degrade the light transmission performance. For example, in order to improve the weather resistance and the durability of the cladding and the core, a stabilizer can be added. Furthermore, in order to improve the light transmission performance, a compound having a stimulated emission function for amplifying an optical signal can be added. Adding said compound can amplify an attenuated optical signal by photoexcitation, thus improving the transmission distance and thereby enabling use as a fiber amplifier in a part of light transmission link. These additives can also be added to the above-mentioned starting monomer, then polymerized, and thus be included in the core and the cladding. It is preferable, as described in JP-A-08-110420, to use a material that is a solid at a temperature up to and including 70° C. as the refractive index adjusting agent since the dopant mobility can be suppressed, thereby inhibiting diffusion during drawing.

When polymerizing a starting monomer for the core and the cladding, in order to control the polymerization state and the polymerization rate and control the molecular weight so that it is suitable for a hot drawing process, a polymerization initiator and a polymerization regulator (for example, a mercapto compound such as n-butylmercaptan or n-laurylmercaptan as a chain transfer agent) can be added. The polymerization initiator can be chosen appropriately according to the monomer used, and examples thereof include benzoyl peroxide (BPO), t-butyl peroxy-2-ethylhexanate (PBO), di-t-butyl peroxide (PBD), t-butyl peroxyisopropylcarbonate (PBI), and n-butyl-4,4-bis(tbutylperoxy)valerate (PHV). The polymerization regulator is used mainly for regulating the molecular weight of the polymer and can be chosen appropriately according to the monomer, and examples thereof include 1-butanethiol, and dodecylmercaptan. They can be used in combinations of two or more types.

Modes for carrying out the present invention are now explained in detail.

One embodiment in which the production process of the present invention is applied to a process for producing an optical fiber comprises a first step of forming a material that seals one end of a hollow cladding tube, a second step of preparing the hollow cladding tube (for example, a cylindrical tube) with one end sealed, a third step of forming a region that becomes a core by carrying out thermal polymerization in the hollow part of the cladding tube and preparing a preform comprising regions corresponding to the core and the cladding, and a fourth step of drawing the preform thus obtained. In the second step, while rotating a container containing a composition including a monomer and a polymer of the monomer, the monomer is polymerized, thus forming a hollow cladding tube.

In the first step of the above-mentioned embodiment, a material is prepared for sealing one end of the hollow (for example, cylindrical) cladding tube that is to be formed. The sealing material is a polymer that is substantially insoluble in the starting monomer for the preform that is to be formed, interacts with and completely bonds to the polymer forming the preform, and is positioned in advance at one end of a cylindrical container. In the second step, the hollow (for example, cylindrical) cladding tube with one end sealed is prepared. The cladding tube can be prepared by polymerizing the starting monomer while rotating the cylindrical container to which has been added a composition containing the monomer and the polymer of the monomer (preferably rotating in a state in which the axis of the cylinder is maintained horizontal). In this stage, the material that seals one end during rotational polymerization is preferably held by at least one end, and it is preferably taken out quickly when polymerization is completed. As the material that seals one end, a material that does not melt during thermal polymerization should be chosen, and its melting point is preferably at least the polymerization temperature Tc when forming the cladding tube. In this case, when the polymerization for the cladding tube is completed, the cladding tube with one end completely sealed can be suitably prepared.

Together with the monomer and the polymer of the monomer, it is possible to add to the container a polymerization initiator, a polymerization regulator, if desired a stabilizer, etc.

It is preferable that the molecular weight of the polymer of the monomer, the polymer being used as the starting material for the cladding tube, is the same as the molecular weight of the polymer formed by rotational polymerization. When the molecular weights of the two polymers are the same, various properties including the optical properties become uniform, and the productivity of a high performance plastic optical fiber can be further improved. The molecular weights of the two polymers can be made substantially identical by injecting a polymerization regulator into the container together with the monomer, and regulating with the polymerization regulator the molecular weight of the polymer formed by polymerization of the monomer. The weight average degree of polymerization of the two polymers is preferably 400 to 1200, more preferably 500 to 1000, and yet more preferably 800 to 1000. When the polymer molecular weight is in the above-mentioned ranges, the subsequent drawing step can be carried out stably. The above-mentioned polymerization regulator is generally added preferably at 0.10 to 0.40 wt % relative to the monomer, and more preferably at 0.15 to 0.30 wt %.

After the above-mentioned rotational polymerization, in order to complete the reaction of remaining monomer and polymerization initiator, the structure obtained may be subjected to a thermal treatment at a temperature higher than the polymerization temperature of the rotational polymerization.

The size of the container used in the second step, the amount of starting composition injected therein for the cladding tube, and the rotational speed per unit time during the rotational polymerization can be determined appropriately according to the size of a target plastic optical fiber (or preform).

In the above-mentioned third step, the starting monomer for the core is injected into the hollow part of the cladding tube prepared in the above-mentioned second step, and the monomer is polymerized. It is possible to add, together with the monomer, a polymerization initiator, a polymerization regulator, if desired a refractive index adjusting agent, etc. The amounts thereof added can be determined appropriately in a preferable range according to the type of monomer used, etc., and the polymerization initiator is generally added preferably at 0.005 to 0.050 wt % relative to the monomer, and more preferably 0.010 to 0.020 wt %. The above-mentioned chain transfer agent is generally added at 0.10 to 0.40 wt % relative to the monomer, and more preferably 0.15 to 0.30 wt %. In the present embodiment, it is also possible to impart a refractive index distribution to a region that becomes the core using two or more types of monomers, etc. without using a refractive index adjusting agent.

In the above-mentioned third step, the core starting monomer, with which the hollow part of the cladding tube is filled, is polymerized. Polymerization of the monomer proceeds from the cladding tube surface side to the center in the radial direction of a cross section. In the case where two or more types of monomers are used, a monomer having high affinity for the polymer forming the cladding tube become localized on the surface of the cladding tube and mainly polymerizes there, thereby forming a polymer having a high proportion of said monomer. Toward the center, the proportion of the high affinity monomer in the polymer so formed decreases, and the proportion of other monomer increases. In this way, a distribution in the monomer composition is caused in a region forming the core, and as a result a refractive index distribution is introduced. Furthermore, when polymerizing a monomer together with a refractive index adjusting agent, as described in WO 93/08488, polymerization proceeds while the core liquid dissolves the inner wall of the cladding and the cladding-forming polymer swells into a gel.

At this point, the monomer, which has a high affinity for the polymer forming the cladding tube, becomes localized on the surface of the cladding tube and polymerizes there, and a polymer having a lower concentration of the refractive index adjusting agent is formed on the outer side. The proportion of refractive index adjusting agent in the polymer so formed increases toward the center. In this way, a distribution in the concentration of the refractive index adjusting agent is caused in a region forming the core, and as a result a refractive index distribution is introduced.

As described above, in the third step, a refractive index distribution can be introduced in the region forming the core, but since areas having different refractive indexes from each other have different thermal behavior from each other, if polymerization is carried out at a constant temperature, the responsiveness of volume shrinkage caused by the polymerization reaction is made to vary in the region forming the core due to the difference in thermal behavior, and there is a possibility that bubbles might be trapped in the preform or microvoids might be formed therein, and when thermally drawing the preform so obtained a large number of bubbles might be generated. When the polymerization temperature is too low, the polymerization efficiency deteriorates, the productivity is greatly degraded, the polymerization becomes incomplete, the light transparency deteriorates, and the light transmission performance of the optical fiber so prepared is degraded. On the other hand, when the initial polymerization temperature is too high, the initial polymerization rate greatly increases, the shrinkage occurring in the region forming the core cannot be responded to and relaxed, and there is a very high tendency for bubbles to be generated. It is therefore preferable to employ an appropriate polymerization temperature according to the monomer used. For example, in the case where MMA is used as a starting material for the core, the polymerization temperature is preferably 50° C. to 150° C., and more preferably 80° C. to 120° C.

Generation of bubbles can be further reduced by dehydrating and/or degassing the starting monomer for the core under a vacuum atmosphere before injecting the monomer into the hollow part of the cladding tube.

It is also preferable to use a polymerization initiator that has a 10-hour half-life temperature of at least the boiling point of the monomer and to polymerize up to a time corresponding to at least 10% of the half-life of the polymerization initiator. When polymerizing under these conditions, the initial polymerization rate can be decreased, the responsiveness to volume shrinkage during initial polymerization can be improved, the inclusion of bubbles in the preform due to volume shrinkage can be reduced as a result, and the productivity can be enhanced. When methyl methacrylate (MMA) is used as the monomer, among the polymerization initiators cited above, the polymerization initiators having a 10-hour half-life temperature of at least the boiling point of MMA correspond to PBD and PHV. For example, in the case where MMA is used as the monomer and PBD is used as the polymerization initiator, the polymerization is preferably carried out by maintaining the initial polymerization temperature at 100° C. to 110° C. for 48 to 72 hours, and subsequently increasing the temperature to 120° C. to 140° C. and polymerizing for 24 to 48 hours, and in the case where PHV is used as the polymerization initiator, the polymerization is preferably carried out by maintaining the initial polymerization temperature at 100° C. to 110° C. for 4 to 24 hours, and subsequently increasing the temperature to 120° C. to 140° C. and polymerizing for 24 to 48 hours. The temperature increase can be carried out stepwise or continuously, but the time taken to increase the temperature is preferably short.

In the third step, polymerization may be carried out under increased pressure as described in JP-A-9-269424 or under reduced pressure as described in WO 93/08488 (hereinafter, polymerization under increased pressure is called ‘increased pressure polymerization’). When carrying out increased pressure polymerization, the cladding tube into which the monomer is injected is inserted into a hollow part of a jig and polymerization is preferably carried out while it is supported in the jig. The jig has a shape having a hollow into which the above-mentioned structure can be inserted, and the hollow part preferably has a shape similar to that of the above-mentioned structure. For example, in an embodiment where the cladding tube is cylindrical, the jig is preferably cylindrical. The jig supports the cladding tube while suppressing deformation of the cladding tube during increased pressure polymerization and at the same relaxing shrinkage of the region forming the core as the increased pressure polymerization proceeds. The hollow part of the jig therefore has a diameter larger than the outer diameter of the cladding tube and preferably supports the cladding tube in a non-contact state. The hollow part of the jig preferably has a diameter that is larger than the outer diameter of the cladding tube by 0.1% to 40%, and more preferably has a diameter that is larger by 10% to 20%. In the present embodiment, since the jig is cylindrical, the inner diameter of the jig is preferably larger than the external diameter of the cladding tube by only 0.1% to 40%, and more preferably by only 10% to 20%.

The cladding tube can be placed in a polymerization container while being inserted into the hollow part of the jig. Within the polymerization container, the cladding tube is preferably disposed with the height direction of the cylinder vertical. After the cladding tube is placed within the polymerization container in a state in which the cladding tube is supported by the jig, the pressure of the interior of the polymerization container can be increased. In the case where the pressure is increased, the interior of the polymerization container is pressurized with an inert gas such as nitrogen, and the increased pressure polymerization is preferably carried out under the inert gas atmosphere. The preferable pressure range during polymerization depends on the monomer used, and the pressure during polymerization is generally preferably on the order of 0.01 to 1.0 MPa.

A plastic optical fiber preform is obtained via the first, second and third steps.

In the present embodiment, as the second and third steps, steps of thermally polymerizing a monomer are illustrated, but a monomer can be polymerized by irradiation with light such as ultraviolet light.

In the fourth step, the preform prepared in the second step is processed to give a desired optical transmitter. For example, a flat lens can be obtained by slicing the preform, or a plastic optical fiber can be obtained by melt drawing. In particular, owing to a refractive index distribution in the region forming the core of the perform, a plastic optical fiber having high-speed light transmission performance can be produced stably with high productivity.

In the case of processing into an optical fiber, the preform is drawn while heating. The heating temperature can be determined appropriately according to the material, etc. of the preform, and in general it is preferably 180° C. to 250° C. Drawing conditions (drawing temperature, etc.) can be determined appropriately while taking into consideration the diameter of the preform obtained, the diameter of a desired plastic optical fiber, the materials used, etc. For example, with regard to drawing tension, it is preferably set at 10 gf or above in order to orient a molten plastic as in JP-A-7-234322, and it is set at 100 gf or below in order to eliminate distortion after melt drawing as in JP-A-7-234324. Furthermore, as in JP-A-8-106015, a method in which preheating is carried out when drawing can be employed.

With regard to the fibers obtained by the above-mentioned methods, flexural and lateral pressure properties of the fiber can be improved by defining the elongation at break and the hardness of the strands obtained as in JP-A-7-244220.

The plastic optical fiber drawn in the fourth step can be put into various applications without any further treatment. It is also possible to put it into various applications in a form where it has, for the purpose of protection and reinforcement, a coating layer on the outside, a textile layer, and/or where a plurality of fibers are bundled.

With regard to a coating process, for example, in the case where a coating is provided on a fiber strand, the fiber strand is made to pass through opposing dies having a hole through which the fiber strand passes, a space between the opposing dies is filled with a resin for coating, and moving the fiber strand between the dies can form a coating on the fiber.

In order to protect the inner fiber from being exposed to stress when it is flexed, the coating layer is desirably not fused with the fiber strand.

Furthermore, since the fiber strand receives thermal damage by contact with a molten resin, it is desirable to choose a speed of movement that can minimize the damage and a resin that can melt at a low temperature.

The thickness of the coating layer depends on the melting temperature of the coating material, the speed that the strand is pulled through, and the cooling temperature of the coating layer.

In addition, a method in which an optical member is coated with a monomer, which is then polymerized, a method in which it is wrapped with a sheet, a method in which an optical member is made to pass through an extrusion-molded hollow tube, etc. are known.

In accordance with the process for producing a plastic optical member of the present invention, in the case where polymerization of a core is completed with high productivity by injecting a polymerizable monomer into the hollow part of a hollow cladding tube, the polymerization of the core can be carried out with high productivity even when severe conditions such as increased or reduced pressure are needed.

### EXAMPLES

The present invention is explained more specifically below by means of examples. Materials, reagents, proportions, operations, etc. shown in the examples below can be changed appropriately as long as the spirit of the present invention is maintained. The scope of the present invention is therefore not limited by the specific examples shown below.

### Example 1

A cylindrical glass container was prepared having a length of 600 mm and an inner diameter of 22 mm, which corresponded to the outer diameter of a preform that was to be formed; while maintaining the longitudinal direction of the glass tube vertical, 8 g of poly(vinylidene fluoride) (PVDF) pellets was added thereto as an end-sealing material, and it was heated and melted in an oil bath at 230° C. for 30 minutes. The poly(vinylidene fluoride) melted completely, and a resin for sealing one end of a cladding tube was formed at the bottom of the glass tube. Next, in a glass flask an MMA monomer having a moisture content of 0.008% was mixed with 0.4 wt % of t-butyl peroxy-2-ethylhexanate as a polymerization initiator and 0.5 wt % of n-laurylmercaptan as a polymerization regulator (chain transfer agent), the mixture was poured into the glass container with the sealing resin at one end, prepolymerized for 1 hour and 30 minutes, and then thermally polymerized at 70° C. for 3 hours while maintaining the container horizontal and rotating it at 3,000 rpm. This was followed by a thermal treatment at 90° C. for 24 hours to give a hollow cylindrical tube made of PMMA with one end sealed with PVDF.

The melting point of PVDF is 158° C. to 178° C.; when forming the cylindrical tube no melting, deformation, etc. were observed, and the PVDF was completely attached to said one end of the cylindrical tube. The cylindrical tube made of PMMA had neither eccentricity, variation of the inner wall, nor trapping of bubbles, and it was a perfect hollow cylindrical tube. Furthermore, the outer periphery had neither deformation nor distortion, and it was confirmed that it did not receive any stress due to deformation of the tube during the rotational polymerization. The weight average molecular weight of the PMMA forming the cylindrical tube thus obtained was Mw=80,000. The total light transmittance of the cylindrical tube made of polymerization-solidified PMMA was 93%, and it was confirmed that there was substantially no dissolution of the PVDF in the PMMA cylindrical tube so made.

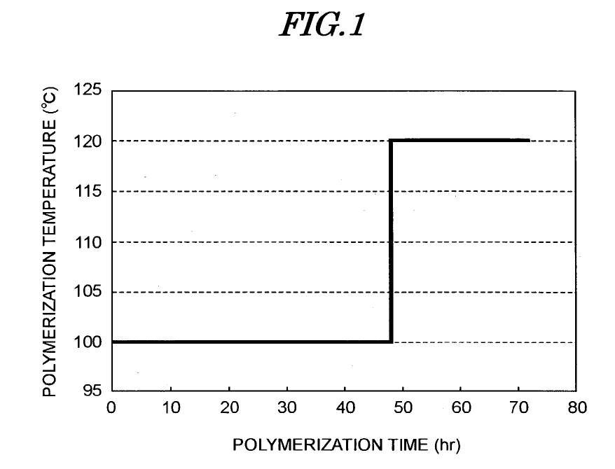

Next, a solution formed by mixing MMA (moisture sufficiently removed), which was a starting material for the core, and diphenyl sulfide as a refractive index adjusting agent at 12.5 wt % relative to the MMA was poured into the hollow part of the PMMA cylindrical tube while filtering by means of a tetrafluoroethylene membrane filter having a precision of 0.2 μm and pouring in the filtrate directly. Di-t-butyl peroxide (10-hour half-life temperature 123.7° C.) was added as an initiator at 0.016 wt % relative to the MMA, and dodecylmercaptan was added as a chain transfer agent at 0.27 wt % relative to the MMA. The cylindrical PMMA tube, into which the MMA, etc. had been poured, was inserted into a glass tube having an inner diameter that was larger than the outer diameter of the PMMA cylindrical tube by only 9%, and placed vertically in an increased pressure polymerization container. Subsequently, the increased pressure polymerization container was flushed with nitrogen, the pressure was then increased to 0.6 MPa, and thermal polymerization was carried out for 48 hours as shown in FIG. 1 while heating at 100° C., which was within the range from at least the boiling point (100° C.) of MMA to at most the glass transition temperature (Tg: 110° C.) of PMMA. Subsequently, thermal polymerization and a thermal treatment were carried out for 24 hours at 120° C., which was within the range from at least the Tg° C. of PMMA to at most (Tg+30)° C., while maintaining the increased pressure state, to give a preform. The half-life of di-t-butyl peroxide at 100° C. is 180 hours. At this point there was no deformation, etc. of the PVDF base, no peel-off at the interface between the PVDF and the PMMA, and no leakage of monomer, and a preform could be produced stably. The preform so obtained did not contain any bubbles due to volume shrinkage when the polymerization was completed. This preform was thermally drawn at 230° C. to give a plastic optical fiber having a diameter of about 700 μm to about 800 μm. The transmission loss of the fiber thus obtained was 165 dB/km at a measurement wavelength of 650 nm.

### Example 2

A cylindrical tube was firstly prepared from PMMA so as to be hollow at both ends, 8 g of PVDF pellets were then placed in a glass tube having a length of 30 cm and an inner diameter of 25 mm, the pellets were heated and melted at 230° C. for 30 minutes while placing the glass tube with its longitudinal direction vertical, and the cylindrical PMMA tube was inserted into the glass tube, fused and then cooled to solidify it. The PMMA cylindrical tube and the PVDF bonded completely to each other, and a preform could be obtained stably in the same manner as in Example 1.

### Comparative Example 1

As a technique for sealing one end of a cylindrical tube, a PMMA plate was bonded to one end of a cylindrical PMMA tube using an epoxy adhesive. There were cases where the bonded part peeled off during increased pressure polymerization and the monomer leaked, and cases where a trace amount of an air phase remaining in the adhesive layer entered the core to generate bubbles, thus resulting in a significant reduction in the productivity.

### Comparative Example 2

As a material for sealing one end of a cylindrical tube, polyethylene oxide (PEO) having a melting point of 69° C. was used, and it softened when a cladding tube was formed and the base part could not be sealed. A base part was formed in the same manner as in Example 2, but the base part melted to a great extent when polymerizing the core, and no preform could be prepared.

### Comparative Example 3

As a material for sealing one end of a cylindrical tube, polystyrene (PS) was used, and although base parts could be formed stably in the same manner as in Examples 1 and 2, when following Example 1 the PS was eluted into the MMA during formation of a hollow tube and the total light transmittance of the hollow tube decreased to 85%, and when following Examples 1 and 2 the base parts were eluted into MMA during polymerization of the cores and when fibers were formed the transmission loss was 250 dB/km.

What is claimed is:

1. A process for producing a plastic optical member, the process comprising:
injecting a polymerizable monomer composition into a hollow tube made of a plastic; and
polymerizing the composition within the hollow tube;
wherein prior to injecting the composition one end of the hollow tube is sealed with a resin.

2. The process for producing a plastic optical member according to claim 1, wherein the resin has a composition different from that of the plastic forming the hollow tube.

3. The process for producing a plastic optical fiber base material according to claim 2, wherein the resin is a fluorine-containing resin.

4. The process for producing a plastic optical fiber base material according to claim 3, wherein the fluorine-containing resin is poly(vinylidene fluoride).

5. The process for producing a plastic optical member according to claim 1 wherein the step of sealing one end of the hollow tube is carried out after forming the hollow tube.

6. The process for producing a plastic optical member according to claim 1 wherein the step of sealing one end of the hollow tube is carried out at substantially the same time as the hollow tube is formed.

7. The process for producing a plastic optical member according to claim 1 wherein the hollow tube is formed after forming an end part that seals the hollow tube.

8. The process for producing a plastic optical member according to claim 2 wherein the resin used for sealing comprises a material having an interaction with the plastic of the hollow tube.

9. The process for producing a plastic optical member according to claim 2 wherein the resin used for sealing comprises a material that does not dissolve in the polymerizable composition.

10. The process for producing a plastic optical member according to claim 1 wherein the melting point of the resin that seals one end of the hollow tube is equal to or greater than a temperature employed for cladding polymerization and a temperature employed for core polymerization.

11. A process for producing a plastic optical fiber base material, the process comprising:
injecting a polymerizable monomer composition into a hollow tube made of a plastic; and
polymerizing the composition within the hollow tube;
wherein prior to injecting the composition one end of the hollow tube is sealed with a resin.

12. The process for producing a plastic optical fiber base material according to claim 1, wherein the resin has a composition different from that of the plastic forming the hollow tube.

13. The process for producing a plastic optical fiber base material according to claim 11 wherein the refractive index distribution of the optical fiber base material varies, in a cross section, from the center to the outside.

14. The process for producing a plastic optical fiber base material according to claim 11, the process further comprising:
forming in advance, from a fluorine-containing resin, an end for sealing one end of a hollow cladding tube; then
forming, by polymerization of a methacrylate ester monomer, the hollow cladding tube with one end sealed with the fluorine-containing resin; and then
forming, by polymerization of a methacrylate ester monomer, a core within the hollow part of the cladding tube.

15. A process for producing a plastic optical fiber, the process comprising:
drawing the plastic optical fiber base material obtained by the production process according to claim 11.

16. A plastic optical member obtained by the production process according to claim 1.

17. A plastic optical fiber obtained by the production process according to claim 15.

18. A plastic optical member obtained by processing a plastic optical fiber base material obtained by the production process according to claim 13, wherein the refractive index distribution varies, in a cross section, from the center to the outside.

19. A plastic optical fiber obtained by drawing a plastic optical fiber base material obtained by the production process according to claim 13, wherein the refractive index distribution varies, in a cross section, from the center to the outside.
